(19) United States
(12) Patent Application Publication
(10) Pub. No.: US 2006/0251848 A1
(43) Pub. Date: Nov. 9, 2006

(54) Optical information storage medium possessing a multilayer coating

(76) Inventors: Sean E. Armstrong, East Greenbush, NY (US); Karin Ezbiansky Pavese, New York, NY (US)

Correspondence Address: DILWORTH & BARRESE, LLP, 333 EARLE OVINGTON BLVD., UNIONDALE, NY, 11553, US

(21) Appl. No.: 11/312,145

(22) Filed: Dec. 20, 2005

Related U.S. Application Data
(60) Provisional application No. 60/678,990, filed on May 9, 2005.

(51) Int. Cl. B32B 3/02

(52) U.S. Cl. 428/64.4

(57) ABSTRACT

A high capacity optical information storage medium, e.g., a Blu-ray Disc, possesses a multilayer coating on a surface thereof, the coating comprising: a) a light transmission layer in adherent contact with a surface of the optical information storage medium, the light transmission layer being obtained by curing a first curable composition comprising at least one monomer possessing at least one of acrylate and epoxy functionality; and, b) a hardcoat layer in adherent contact with the light transmission layer, the hardcoat layer being obtained by curing a second curable composition comprising functionalized colloidal silica and at least one monomer possessing at least one of acrylate and epoxy functionality.

### CROSS REFERENCE TO RELATED APPLICATION

This application claims the benefit of U.S. provisional application Ser. No. 60/678,990, filed May 9, 2005, the entire contents of which are incorporated by reference herein.

### BACKGROUND OF THE INVENTION

This invention relates to a multilayer coating for a high capacity optical information storage medium such as a Blu-ray Disc.

It is therefore desirable to provide a coating for optical information storage media, particularly the more recent Blu-ray Discs, that not only dispenses with the need for a protective cartridge but replaces the current PC cover layer with a more economical alternative.

A new form of optical information storage medium, the so-called “Blu-ray” Disc (BD) technology, has only recently made its commercial appearance. At present, a Blu-ray optical information storage disc consists of a 1.1 mm substrate layer that is sputtered on one side with a metal or metal alloy as a reflective layer, a thin information layer (for BD-ROM), a recordable layer (for BD-R) or a re-recordable layer (for BD-RE) and, finally, a 100 micron protective topcoat, or cover, layer. The cover layer consists of a relatively expensive solvent-casted polycarbonate (PC) film of approximately 100 microns thickness bonded via an adhesive to the information layer, recordable layer or re-recordable layer, as the case may be, of the substrate. Because this PC film readily scratches and acquires fingerprints, the current commercial version of the Blu-ray Disc is enclosed within a protective cartridge, a component that adds significantly to the cost of the product. The information, recordable or re-recordable layer of a Blu-ray disc is only about 100 microns below its surface therefore thus requiring increased surface integrity compared to that which is acceptable for a conventional compact disc (CD) or digital versatile disc (DVD) surface.

Efforts are currently being made to replace the protective cartridge of a Blu-ray Disc with a protective coating on the disc and even to replacing the PC film used as the cover layer with a lower cost but still effective substitute. PC film is not only an expensive material, it is difficult to apply in the disc manufacturing process. Abrasion resistance and scratch resistance can in general be achieved with highly crosslinked resins. However, most organic resins shrink upon polymerization. Shrinkage of the cover layer upon curing creates stress between it and the substrate to which it is applied. This stress in turn create what is referred to as disc tilt. Because of the miniaturization of the information pits and the necessary precision requirement of the laser light, particularly in the case of Blu-ray media, excessive disc tilt must be avoided.

One approach being considered to improve the high capacity optical information media technology such as the Blu-ray Disc consists of a 2-layer spincoatable system wherein a first 50-150 micron light transmission layer is applied to an information-containing substrate followed by a second 0.1-10 micron hardcoat layer which provides abrasion resistance and anti-fingerprint properties for the underlying light transmission layer. See, e.g., U.S. Pat. No. 6,924,019, the entire contents of which are incorporated herein by reference.

### BRIEF DESCRIPTION OF THE INVENTION

In accordance with the present invention, there is provided an optical information storage medium possessing a multilayer coating on a surface thereof, the coating comprising:
a) a light transmission layer in adherent contact with a surface of the optical information storage medium, the light transmission layer being obtained by curing a first curable composition comprising at least one monomer possessing at least one of acrylate and epoxy functionality; and,
b) a hardcoat layer in adherent contact with the light transmission layer, the hardcoat layer being obtained by curing a second curable composition comprising functionalized colloidal silica and at least one monomer possessing at least one of acrylate and epoxy functionality.

The foregoing multilayer coating in its hardcoat layer provides a scratch and abrasion resistant protective layer for the underlying light transmission layer while exhibiting low shrinkage and minimal tilt upon curing, characteristics which make it well-suited for application to high capacity optical information storage media such as the Blu-ray Disc.

The term “monomer” as used herein shall be understood to include polymerizable compounds whether they be of the non-polymeric, oligomeric or polymeric variety.

The term “acrylate” shall be understood herein to refer to acrylate and/or methacrylate.

The term “curable” shall be understood herein to mean the full or partial curing of a composition comprising one or more curable monomers, e.g., to at least the “green” strength of the composition, the curing being achieved by any suitable means, e.g., thermal curing, curing with V, E-beam, etc., in accordance with known and conventional procedures.

The expression “functionalized colloidal silica” as used herein shall be understood to mean a colloidal silica which, by having been rendered hydrophobic, becomes compatible with the curable monomer(s) with which it is admixed to provide the curable composition of the invention, the compatibilization being achieved by chemically reacting the colloidal silica with a silane, referred to herein as a “functionalizing silane”, which produces this result. As a result of having been obtained from the reaction of colloidal silica with functionalizing silane, the functionalized colloidal silica component of the curable composition herein may be made to possess organic moieties bonded to the surface of the silica particles that are either essentially chemically inert, e.g., alkyl, cycloalkyl, aryl, alkaryl and aralkyl groups, or are chemically reactive, e.g., alkenyl groups such as allyl and vinyl, acrylate groups, epoxy groups, or combinations of such chemically reactive groups, e.g., acrylate and epoxy groups.

The term “substrate” shall be understood herein to mean a preformed layer, made up of a single layer or assembly of individual layers, to at least one side of which a multilayer coating in accordance with the present invention will be applied.

### DETAILED DESCRIPTION OF THE INVENTION

The multilayer coating of the present invention is adherently applied to a high capacity optical information medium, e.g., the aforementioned Blu-ray Disc, in two separate operations or series of operations.

In the first of these operations or series of operations which results in the formation of the light transmission layer, a first curable composition comprising at least one monomer possessing at least one of acrylate and epoxy functionality and, optionally, at least one curing agent therefore, is applied by any of the known and conventional procedures of spincoating to the substrate of an optical information storage medium to a suitable thickness, e.g., in the case of a Blu-ray Disc, from about 90 to about 99 microns in a first embodiment and from about 95 to about 98 microns in a second embodiment, and thereafter cured, e.g., in accordance with procedures well known in the art.

Useful acrylate-containing monomers that can be incorporated in the first curable composition of the present invention include one or more mono-, di-, tri-, tetra- and/or higher functionality acrylates numerous specific examples of which are well known in the art.

Useful monoacrylates include alkylacrylates such as methylacrylate, propyl acrylate, butylacrylate, methylmethacrylate, propylmethacrylate, butylmethacrylate, ethylhexylmethacrylate, etc., 2-(2-ethoxyethoxy) ethyl acrylate, 2-phenoxyethyl acrylate, 2-phenoxyethyl methacrylate, alkoxylated lauryl acrylate, alkoxylated phenolacrylate, alkoxylated phenolmethacrylate, alkoxylated tetrahydrofurfuryl acrylate, caprolactone acrylate, cyclic trimethylolpropane formal acrylate, dicyclopentadienyl methacrylate, ethoxylated (10) hydroxyethyl methacrylate, ethoxylated (4) nonyl phenol acrylate, ethoxylated (4) nonyl phenol methacrylate, ethoxylated nonyl phenol acrylate, isobornyl acrylate, isobornyl methacrylate, isodecyl acrylate, isodecyl methacrylate, isooctyl acrylate, lauryl acrylate, lauryl methacrylate, methacrylate functional monomer, methoxy polyethylene glycol (350) monoacrylate, methoxy polyethylene glycol (350) monomethacrylate, methoxy polyethylene glycol (550) monoacrylate, methoxy polyethylene glycol (550) monomethacrylate, polyurethane acrylate, polyurethane methacrylate, octyldecyl acrylate, polypropylene glycol monomethacrylate, propoxylated (2) allyl methacrylate, stearyl acrylate, stearyl methacrylate, tetrahydrofurfuryl acrylate, tetrahydrofurfuryl methacrylate, tridecyl acrylate, tridecyl methacrylate, and the like.

Useful diacrylates include 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, alkoxylated cyclohexane dimethanol diacrylate, alkoxylated cyclohexane dimethanol diacrylate, alkoxylated cyclohexane dimethanol dimethacrylate, alkoxylated hexanediol diacrylate, alkoxylated hexanediol dimethacrylate, alkoxylated neopentyl glycol diacrylate, alkoxylated neopentyl glycol dimethacrylate, cyclohexane dimethanol diacrylate, cyclohexane dimethanol dimethacrylate, diethylene glycol diacrylate, diethylene glycol dimethacrylate, dipropylene glycol diacrylate, dipropylene glycol dimethacrylate, ethoxylated (10) bisphenol A diacrylate, ethoxylated (1) bisphenol A dimethacrylate, ethoxylated (2) bisphenol A diacrylate, ethoxylated (2) bisphenol A dimethacrylate, ethoxylated (3) bisphenol A diacrylate, ethoxylated (3) bisphenol A dimethacrylate, ethoxylated (30) bisphenol A diacrylate, ethoxylated (30) bisphenol A dimethacrylate, ethoxylated (4) bisphenol A diacrylate, ethoxylated (4) bisphenol A dimethacrylate, ethoxylated (8) bisphenol A dimethacrylate, ethoxylated (8) bisphenol A dimethacrylate, ethoxylated (6) bisphenol A dimethacrylate, ethoxylated (6) bisphenol A dimethacrylate, ethylene glycol diacrylate,, ethylene glycol dimethacrylate, neopentyl glycol diacrylate, neopentyl glycol dimethacrylate, polyethylene glycol (200) diacrylate, polyethylene glycol (200) dimethacrylate, polyethylene glycol (400) diacrylate, polyethylene glycol (400) dimethacrylate, polyethylene glycol (600) diacrylate, polyethylene glycol (600) dimethacrylate, polypropylene (400) diethacrylate, polypropylene glycol (400) dimethacrylate, propoxylated (2) neopentyl glycol diacrylate, propoxylated (2) neopentyl glycol dimethacrylate, tetraethylene glycol diacrylate, tetraethylene glycol dimethacrylate, tricyclodecane dimethanol diacrylate, tricyclodecane dimethanol dimethacrylate, triethylene glycol diacrylate, triethylene glycol dimethacrylate, tripropylene glycol diacrylate, tripropylene glycol dimethacrylate, and the like.

Among the trifunctional acrylates that can be used herein are ethoxylated (15) trimethylolpropane triacrylate, ethoxylated (3) trimethylolpropane triacrylate, ethoxylated (15) trimethylolpropane triacrylate, ethoxylated (6) trimethylolpropane triacrylate, ethoxylated (9) trimethylolpropane triacrylate, ethoxylated (20) trimethylolpropane triacrylate, highly propoxylated (5.5) glyceryl triacrylate, low viscosity trimethylolpropane triacrylate, pentaerythritol triacrylate, propoxylated (3) glyceryl triacrylate, propoxylated (3) glyceryl trimethacrylate, propoxylated (3) trimethylolpropane triacrylate, propoxylated (6) trimethylolpropane triacrylate, trimethylolpropane triacrylate, trimethylolpropane trimethacrylate, tris (2-hydroxyethyl) isocyanurate triacrylate, tris (2-hydroxyethyl) isocyanurate triacrylate, and the like.

Useful tetra- and higher functionality acrylates and methacrylates that can be used herein include ditrimethylolpropane tetraacrylate, dipentaerythritol pentaacrylate, ethoxylated (5) pentaerythritol tetraacrylate, low viscosity dipentaerythritol pentaacrylate, pentaacrylate ester, pentaerythritol tetraacrylate, and the like.

Additional useful multifunctional acrylates include polyester and alkyl (novolac) acrylates, e.g., those disclosed in U.S. Pat. No. 6,714,712, the entire contents of which are incorporated by reference herein, and the urethane diacrylates, in particular those obtained by reacting an isocyanate-terminated polyurethane derived from a polyether diol or polyester diol and an organic diisocyanate such as isophorone diisocyanate with an active hydrogen-containing acrylate such as hydroxyethylacrylate or hydroxyethylmethacrylate. Especially useful are the urethane diacrylates of commerce diluted with another acrylate of lower viscosity to provide an acrylate monomer mixture of more readily manageable viscosity.

Still other acrylate monomers that can be used to provide the first curable composition include those acrylates possessing at least one other type of functionality, e.g., allyl, vinyl or epoxy functionality. Examples of such acrylate monomers include glycidyl acrylate, glycidyl methacrylate, phenol novolac epoxide acrylate and methacrylate, cresol novolac epoxide acrylate and methacrylate, bisphenol A epoxide acrylate and methacrylate, and the like.

Epoxy-containing second curable monomers (i.e., epoxides) that are suitable for use herein include any of those containing at least one epoxy functionality and, advantageously those containing more than one epoxy functionality. Examples of such epoxy-containing monomers include glycidyl esters of mono- and dicarboxylic acids, alkyl glycidyl ethers such as butyl glycidyl ether, phenylglycidyl ether, 2-ethylhexyl glycidyl ether, 3-cyclohexenylmethyl-3-cyclohexenylcarboxylate diepoxide, 2-(3,4-epoxy)cyclohexyl-5,5-spiro-(3,4-epoxy)cyclohexane-m-dioxane, 3,4-epoxycyclohexylmethyl-3,4-epoxycyclo-hexanecarboxylate, 3,4-epoxy-6-methycyclohexylmethyl-3,4-epoxy-6-methyl-cyclohexanecarboxylate, vinyl cyclohexanedioxide, bis(3,4-epoxycyclohexyl-methyl)adipate, bis(3,4-epoxy-6-methylcyclohexylmethyl)adipate, exo-exo bis(2,3-epoxycyclopentyl) ether, endo-exo bis(2,3-epoxycyclopentyl) ether, 2,2-bis(4-(2,3-epoxypropoxy)cyclohexyl)propane, 2,6-bis(2,3-epoxypropoxy-cyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, p-(2,3-epoxy)cyclopentylphenyl-2,3-epoxypropylether, 1-(2,3-epoxypropoxy)phenyl-5,6-epoxyhexadydro-4,7-methanoindane, o-(2,3-epoxy)cyclopentylphenyl-2,3-epoxypropyl ether), 1,2-bis(5-(1,2-epoxy)-4,7-hexahydromethanoindanoxyl)ethane, cyclopentenylphenyl glycidyl ether, cyclohexanediol diglycidyl ether, diglycidyl hexahydrophthalate, diglycidyl ethers of bisphenol A and bisphenol F, alkyl glycidyl ethers; alkyl- and alkenyl-glycidyl esters; alkyl-, mono- and poly-phenol glycidyl ethers; polyglycidyl ethers of pyrocatechol, resorcinol, hydroquinone, 4,4′-dihydroxydiphenyl methane, 4,4′-dihydroxy-3,3′-dimethyldiphenyl methane, 4,4′-dihydroxydiphenyl dimethyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphyenyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; phenol novolac epoxy resin; cresol novolac epoxy resin, sorbitol glycidyl ether, and the like.

Other epoxy monomers that can be used herein include those possessing at least one other type of functionality, e.g., allyl, vinyl or acrylate functionality. Examples of such acrylate monomers include allyl glycidyl ether, vinyl glycidyl ether, glycidyl acrylate, glycidyl methacrylate, phenol novolac epoxide acrylate and methacrylate, cresol novolac epoxide acrylate and methacrylate, bisphenol A epoxide acrylate and methacrylate, and the like.

While the first curable composition of the present invention will over time provide a light transmission layer at ambient conditions, optimum results are achieved by the application of heat and/or the use of one or more curing agents. Thus, e.g., the first curable composition can be cured by an energetic free radical generator such as ultraviolet light, electron beam or gamma radiation, or by one or more chemical free radical generators such as azo compounds and peroxides. The composition can be ultraviolet light-cured if one or more photoinitiators is added prior to curing. There are no special restrictions on the nature of the useful photoinitiators provided they generate radicals by the absorption of energy. Ultraviolet light-sensitive photoinitiators or blends of initiators used in the UV cure of the present curable composition include 2-hydroxy-2-methyl-1-phenyl-propan-1-one (Darocur 1173, Ciba Specialty Chemicals) and 2,2 dimethoxy-2-phenyl-acetol-phenone (Irgacure 651, Ciba Specialty Chemicals).

Additional curing agents include onium catalysts such as bisaryliodonium salts (e.g. bis(dodecylphenyl)iodonium hexafluoroantimonate, (octyloxyphenyl, phenyl)iodonium hexafluoroantimonate, bisaryliodonium tetrakis(pentafluorophenyl) borate), triarylsulphonium salts, and combinations thereof. Preferably, the catalyst is a bisaryliodonium salt. Optionally, an effective amount of free-radical generating compound(s) such as the aromatic pinacols, benzoinalkyl ethers, organic peroxides, and combinations thereof, can be added as optional reagent(s). The free radical generating compound or mixture of such compounds facilitates decomposition of onium salts at a lower temperature.

Also useful herein as curing agents for epoxy resin monomer(s) are the superacid salts, e.g., the urea-superacid salts disclosed in U.S. Pat. No. 5,278,247, the entire contents of which are incorporated by reference herein.

In general, from about 0.05 to about 5 weight percent based on the total solids in the composition of the foregoing curing agents will cause the first curable composition herein to cure.

As those skilled in the art will appreciate, the first curable composition can contain one or more other optional ingredients such as UV absorbers, stabilizers, antioxidants, plasticizers, and the like, in known and conventional amounts provided they do not negatively affect in any appreciable way the light transmission properties of the layer obtained therefrom.

As previously indicated, application of the first curable composition to the desired surface of the high capacity optical information storage medium can be readily and conveniently achieved by any of the known and conventional spincoating procedures. In one embodiment, spincoating conditions include a spin rate of about 500-3000 rpm for 1 to 30 seconds to provide a curable layer of approximately 50-150 microns thickness and, for a Blu-ray Disc, a layer of approximately 90 to about 99 microns thickness. A typical curing procedure for the layer of first curable composition involves the use of a Fusion D or H bulb with a set intensity ranging between 0.384-2.8 W/cm² and a dosage of 0.304-2 J/cm² or Xenon Flash Bulb. Curing can be partial or complete; if partial, complete curing will be achieved when curing the second curable composition which provides the outer hardcoat protective layer.

In the second of the two operations or series of operations which provides the hardcoat layer of the multilayer coating herein, a second curable composition comprising functionalized colloidal silica, at least one monomer possessing at least one of acrylate and epoxy functionality and, optionally, at least one curing agent, is applied to the now at least partially cured light transmission layer, also by spincoating, to a suitable thickness, e.g., in the case of a Blu-ray Disc, from about 1 to about 10 microns in a first embodiment and from about 2 to about 5 microns in a second embodiment, to provide a total combined thickness of light transmission and hardcoat layers of about 100 microns, and thereafter cured, e.g., as described above in connection with the curing of the first curable composition.

The second curable composition is obtained by initially providing a functionalized colloidal silica. The functionalized colloidal silica is advantageously obtained by reacting a functionalizing silane with a finely divided colloidal silica. The functionalized colloidal silica is thereafter combined with at least one acrylate- and/or epoxy-containing monomer to provide the second curable composition.

Colloidal silica is commercially supplied as a dispersion of nano-sized silica (SiO₂) particles in an aqueous or other solvent medium. The colloidal silica contains up to about 85 weight percent silicon dioxide (SiO₂) and typically up to about 80 weight percent silicon dioxide. The nominal median particle size of the colloidal silica is typically in a range of from about 1 to about 250 nanometers (nm) which, for this invention, advantageously does not exceed about 50 nm and more advantageously does not exceed about 25 nm.

Silanes useful for functionalizing colloidal silica include those of the general formula:
(R¹)ₐSi(OR²)₄₋ₐ
wherein each R¹ is, independently, a monovalent alkyl, cycloalkyl, aryl, alkaryl or aralkyl group of up to 18 carbon atoms, optionally possessing at least one chemically reactive functionality selected from the group consisting of alkenyl, acrylate and epoxy, and each R² is, independently, a monovalent hydrocarbon radical of up to 18 carbon atoms and “a” is a whole number of from 1 to 3.

Silanes that can be used for functionalizing colloidal silica include alkyl-, cycloalkyl-, aryl-, alkaryl- and aralkyl-containing silanes such as phenyldimethylmethoxysilane, phenylmethyldimethoxysilane, cyclohexylmethyldimethoxysilane, phenyltrimethoxysilane, methyltrimethoxysilane, and the like; alkenyl-containing silanes, e.g., the vinylalkoxysilanes such as vinylmethyldimethoxysilane, vinylmethyldiethoxysilane, vinyldimethylmethoxysilane, vinyldimethylethoxysilane, vinyltrimethoxysilane, vinyltriethoxysilane, and the like, allylsilanes such as the allylalkyl silanes disclosed in U.S. Pat. No. 5,420,323, including those additionally containing epoxy, specifically, glycidoxy, functionality, and the beta-substituted allylsilanes such as those disclosed in U.S. Pat. No. 4,898,959, the contents of both U.S. patents being incorporated by reference herein; acrylate-containing silanes such as 3-acryloxypropylmethyldiethoxysilane, 3-acryloxyproplymethyldimethoxysilane, 3-acryloxypropyltrimethoxysilane, 2-methacryloxethylmethyldiethoxysilane, 2-methacryloxyethylmethyldimethoxysilane, 2-methacryloxethyltrimethoxysilane, 2-acryloxyethyltrimethoxysilane, 3-methylacryloxypropyl-3-methacryloxypropyltriethoxysilane, 3-acryloxypropyltriethoxysilane, 3-acryloxypropyldimethyl-ethoxysilane, 2-methacryloxyethyltriethoxysilane, 2-acryloxyethyltriethoxysilane, and the like; and, epoxy-containing silanes such as 2-(3,4-epoxycyclohexyl)ethyl-trimethoxysilane, 3-glycidoxypropyltrimethoxysilane, 3-acryloxypropylmethyl-diethoxysilane, 3-acryloxyproplymethyldimethoxysilane, 3-acryloxypropyltri-methoxysilane, 2-methacryloxethylmethyldiethoxysilane, 2-methacryloxyethyl-methyldimethoxysilane, 2-methacryloxethyltrimethoxysilane, 2-acryloxyethyltri-methoxysilane, 3-methylacryloxypropyl-3-methacryloxypropyltriethoxysilane, 3-acryloxypropyltriethoxysilane, 3-acryloxypropyldimethylethoxysilane, 2-methacryloxyethyltriethoxysilane, 2-acryloxyethyltriethoxysilane, and the like.

Functionalized colloidal silica containing two or more different functionalities can be obtained by reacting the colloidal silica with as many different functionalizing silanes with each such silane containing a different functionalizing group. Thus, e.g., colloidal silica can be reacted simultaneously or sequentially with two different silanes, one of which possesses acrylate functionality and the other of which possesses epoxy functionality. It is also within the scope of the invention to functionalize the colloidal silica with a single silane containing two different types of functionality, e.g., allyl and epoxy functionality as in the case of certain of the silanes disclosed in U.S. Pat. No. 5,420,323 referred to above, thus introducing both functionalities into the functionalized colloidal silica.

In general, the colloidal silica can be reacted with from about 5 to about 60 weight percent based thereof of functionalizing silane(s). If desired, the resulting functionalized colloidal silica can be treated with an acid or base to neutralize its pH. An acid or base as well as other catalysts promoting condensation of the silanol groups on the silica particles and the alkoxysilane group(s) on the silane(s) can be used to facilitate the functionalization process. Such catalysts include organotitanium and organotin compounds such as tetrabutyl titanate, titanium isopropoxybis(acetylacetonate), dibutyltin dilaurate, etc., and combinations thereof.

In one embodiment, the functionalization of the colloidal silica can be carried out by adding the functionalizing silane(s) to a commercially available aqueous dispersion of colloidal silica in the weight ratio described above to which an aliphatic alcohol has been added. The resulting composition comprising the colloidal silica and the functionalizing silane(s) in the aliphatic alcohol will be referred to herein as a pre-dispersion. The aliphatic alcohol can be selected from, e.g., isopropanol, t-butanol, 2-butanol methoxypropanol, etc., and combinations thereof. The aliphatic alcohol(s) can be present in an amount of from about 1 to about 10 times the weight of the colloidal silica. In some cases, one or more stabilizers such as 4-hydroxy-2,2,6,6-tetramethylpiperdinyloxy (i.e. 4-hydroxy TEMPO) can be added to this pre-dispersion. In some instances, small amounts of acid or base can be added to adjust the pH of the pre-dispersion. The resulting pre-dispersion is typically heated in a range between about 50° C. and bout 120° C. for a period of from about 1 hour to about 5 hours to effect the reaction of the silane with the silica thereby providing the functionalized colloidal silica.

The cooled pre-dispersion is then further treated to provide a final dispersion of the functionalized colloidal silica by addition of at least one curable monomer which is an aliphatic cyclic acrylate, urethane diacrylate or epoxy resin, and optionally, additional aliphatic solvent which can be selected from, but not limited to, isopropanol, 1-methoxy-2-propanol, 1-methoxy-2-propyl acetate, toluene, etc., and combinations thereof. This final dispersion of the functionalized colloidal silica can be treated with acid or base or with an ion exchange resin to remove acidic or basic impurities, as the case may be. This final dispersion of the functionalized colloidal silica is then concentrated under a vacuum of from about 0.5 Torr to about 250 Torr and at a temperature of from about 20° C. to about 140° C. to remove low boiling materials such as solvent, residual water, etc., the thus-treated concentrated dispersion being referred to herein as a final concentrated dispersion.

If desired, the pre-dispersion or the final dispersion of the functionalized colloidal silica can be further functionalized. In this embodiment, low boiling components are at least partially removed and, subsequently, an appropriate capping agent that will react with residual silanol groups on the surface of the functionalized colloidal silica particles is added to the dispersion in a suitable amount, e.g., from about 0.05 to about 10 times the amount of silica present in the pre-dispersion or final dispersion. Partial removal of low boiling components refers to the removal of at least about 10 weight percent of the total mount of low boiling components, and advantageously, at least about 50 weight percent of the total amount of low boiling components. An effective amount of capping agent caps the functionalized colloidal silica, the capped functionalized colloidal silica being defined herein as a functionalized colloidal silica in which at least about 10 percent, advantageously at least about 20 percent, more advantageously at least about 35 percent, of the free silanol groups present in the corresponding uncapped functionalized colloidal silica have been functionalized by reaction with capping agent. Capping the functionalized colloidal silica effectively can improve the cure of the total curable composition. Formulations which include the capped functionalized colloidal silica typically show better room temperature stability than analogous formulations in which residual silanol groups on the surface of the colloidal silica have not been capped.

Suitable capping agents include hydroxyl-reactive materials such as silylating agents. Examples of a silylating agent include, but are not limited to, hexamethyldisilazane (HMDZ), tetramethyldisilazane, divinyltetramethyldisilazane, diphenyltetramethyldisilazane, N-(trimethylsilyl)diethylamine, 1-(trimethylsilyl)imidazole, trimethylchlorosilane, pentamethylchlorodisiloxane, pentamethyldisiloxane, etc., and combinations thereof. The transparent dispersion is then heated in a range of from about 20° C. to about 140° C. for a period of time ranging from about 0.5 hours to about 48 hours. The resultant mixture is then filtered. If the pre-dispersion was reacted with capping agent, the curable monomer referred to above is added to form the final dispersion. The mixture of functionalized colloidal silica and curable monomer(s) is concentrated at a pressure of from about 0.5 Torr to about 250 Torr to form the final concentrated dispersion. During this process, lower boiling components such as solvent, residual water, byproducts of the capping agent, excess capping agent, and the like, are substantially removed.

Following its preparation, the functionalized colloidal silica component of the curable composition is combined with at least one monomer possessing acrylate and/or epoxy functionality to provide the second curable composition which, on curing, forms the hardcoat layer and completes the preparation of the multilayer coating herein. These acrylate- and epoxy-containing monomers can be selected from among the same classes and species of monomers described above for inclusion in the first curable composition and can be the same or different from the monomer or monomer mixture present in the first curable composition. The functionalized colloidal silica can be present in the second curable composition in widely varying amounts. In a first embodiment, this amount can be about 50-80 weight percent, in a second embodiment, about 10-70 weight percent, and in a third embodiment, about 20-60 weight percent, of the total second curable composition.

The second curable composition can also contain one or more optional components, e.g., any of those mentioned above in connection with the first curable composition, in the usual amounts. It may be advantageous to incorporate one or more surface tension-lowering materials, e.g., silicone fluids and fluoro surfactants, in the second curable composition in order to increase surface slippage of the resulting hardcoat layer which in turn improves its abrasion resistance. This addition of a surface tension lowering material may also serve to enhance the antifingerprint properties of the hardcoat layer as indicated by increased contact angles.

As in the case of the application of the first curable layer and its subsequent curing, the present invention contemplates the use of known and conventional optional curing agents, spincoating procedures and curing procedures for the formulation, application and curing of the second curable composition to provide the hardcoat layer of the multilayer coating herein.

The following example is illustrative of a high capacity optical information storage medium, specifically a Blu-ray Disc, to which has been applied a multilayer coating in accordance with the present invention.

### EXAMPLE

Solutions of first and second curable compositions were prepared and spin coated onto both polycarbonate (PC) (GE OQ 1030) and Noryl® (blend of polyphenylene oxide (PPO) and polystyrene (PS) from GE) substrates in the form of discs having a diameter of 120 mm and a thickness of 1.1 mm. The cure conditions employed Fusion D or H bulb with a set intensity ranging between 1.6-2.8 W/cm² and a dosage of 1-2J/cm². Spincoating conditions were a spinrate of approximately 300 rpm for 30 seconds to provide an approximately 97 micron light transmission layer and about 1400 rpm for about 30 seconds to provide a 3 micron hardcoat protective layer, such thickness dimensions being characteristic of a Blu-ray Disc.

Hardness was measured following the pencil hardness ASTM test D3363. Tilt was measured using a Dr. Schenk PROmeteus MT-146/Blu-ray instrument.

A. Formation of the Light Transmission Layer on the Discs

To a solution containing 50 weight percent aliphatic urethane diacrylate in 50 weight percent hexanediodiacrylate (Ebecryl 230 from UCB Chemicals) was added approximately 9 weight percent 2-hydroxy-2-methyl- 1-phenyl-1-propanone (Darocur 1173, Ciba Specialty Chemicals). The solution of first curable composition was stirred prior to spincoating. A coating with a thickness of 97 microns was applied to both the Noryl® and PC discs and subsequently cured thereon to provide a light transmission layer which is identified below in Table 1 as “Layer A”.

B. Formation of the Hardcoat Layer on the Discs

A dispersion was prepared containing 40 weight percent ethoxylated trimethylolpropane triacrylate (TMPTA, SR454 from Sartomer) and 40 weight percent of colloidal silica material functionalized with methacryloxypropyltrimethoxy silane diluted in hexanedioldiacrylate. To this dispersion were added 7.7 weight percent 2-hydroxy-2-methyl-1-phenol-1-propanone (Darocur 1173) as a photoinitiator and 0.3 weight percent of BYK310 (BYK Chemical Company) as a surface tension-lowering surfactant to provide the second curable composition. The final dispersion constituting the second curable composition was stirred prior to spincoating. Coatings of 3 microns thickness were applied to the PC and Noryl® discs previously provided with Layer A and thereafter cured to provide the hardcoat layer identified below in Table 1 as “Layer B”, the multilayer coating being identified as “Layers A+B” therein.

TABLE 1
Tilt and Pencil Harness Test Results

| | | | Tilt Change | |
|---|---|---|---|---|
| | Viscosity¹ | Coating | post coating | Pencil |
| | (cps@ | Thickness | and curing² | Hardness |
| | 20 1/s, | (μ) (average | (average | (average |
| Layer/Disc | 25° C.) | of 5) | of 5) | of 2)³ |
| Layer A/PC | 500 | 100.56 | −0.48 | H |
| Layer A/Noryl ® | 500 | 98.61 | −0.74 | H |
| Layers A + B/PC | XX (Sol B) | (A + B) | (A + B) | — |
| Layers A + B/ | XX (Sol b) | (A + B) | (A + B) | — |
| Noryl ® | | | | |

¹Data obtained on a TA Instrument Carri-Med Rheometer CSL²₅₀₀ for Layer A and obtained following the WPSTEM P-2 test for Layer B.
²Data obtained using a Dr. Schenk PROmeteus MT-146/Blu-ray instrument.
³Data obtained employing ASTM D3363.

These data indicate that the multilayer coating system of this invention performed well in both the tilt and pencil hardness tests.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention, but that the invention will include all embodiments falling within the scope of the appended claims.

What is claimed is:

1. An optical information storage medium possessing a multilayer coating on a surface thereof, the coating comprising:
a) a light transmission layer in adherent contact with a surface of the optical information storage medium, the light transmission layer being obtained by curing a first curable composition comprising at least one monomer possessing at least one of acrylate and epoxy functionality; and,
b) a hardcoat layer in adherent contact with the light transmission layer, the hardcoat layer being obtained by curing a second curable composition comprising functionalized colloidal silica and at least one monomer possessing at least one of acrylate and epoxy functionality.

2. The optical information storage medium of claim 1 which is a CD, DVD or Blu-ray Disc.

3. The optical information storage medium of claim 1 wherein the light transmission layer possesses a thickness of from about 50 to about 150 microns and the hardcoat layer possesses a thickness of from about 0.1 to about 10 microns.

4. The optical information storage medium of claim 1 wherein the light transmission layer possesses a thickness of from about 90 to about 99 microns and the hardcoat layer possesses a thickness of from about 1 to about 10 microns.

5. The optical information storage medium of claim 1 wherein the light transmission layer possesses a thickness of from about 95 to about 98 microns and the hardcoat layer possesses a thickness of from about 2 to about 5 microns.

6. The optical information storage medium of claim 1 wherein the first and/or second curable composition comprises at least one acrylate monomer selected from the group consisting of methylacrylate, propylacrylate, butylacrylate, methylmethacrylate, propylmethacrylate, butylmethacrylate, ethylhexylmethacrylate, 2-(2-ethoxyethoxy) ethyl acrylate, 2-phenoxyethyl acrylate, 2-phenoxyethyl methacrylate, alkoxylated lauryl acrylate, alkoxylated phenolacrylate, alkoxylated phenolmethacrylate, alkoxylated tetrahydrofurfuryl acrylate, caprolactone acrylate, cyclic trimethylolpropane formal acrylate, dicyclopentadienyl methacrylate, ethoxylated (10) hydroxyethyl methacrylate, ethoxylated (4) nonyl phenol acrylate, ethoxylated (4) nonyl phenol methacrylate, ethoxylated nonyl phenol acrylate, isobornyl acrylate, isobornyl methacrylate, isodecyl acrylate, isodecyl methacrylate, isooctyl acrylate, lauryl acrylate, lauryl methacrylate, methacrylate functional monomer, methoxy polyethylene glycol (350) monoacrylate, methoxy polyethylene glycol (350) monomethacrylate, methoxy polyethylene glycol (550) monoacrylate, methoxy polyethylene glycol (550) monomethacrylate, polyurethane acrylate, polyurethane methacrylate, octyldecyl acrylate, polypropylene glycol monomethacrylate, propoxylated (2) allyl methacrylate, stearyl acrylate, stearyl methacrylate, tetrahydrofurfuryl acrylate, tetrahydrofurfuryl methacrylate, tridecyl acrylate, tridecyl methacrylate, 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, alkoxylated cyclohexane dimethanol diacrylate, alkoxylated cyclohexane dimethanol diacrylate, alkoxylated cyclohexane dimethanol dimethacrylate, alkoxylated hexanediol diacrylate, alkoxylated hexanedoil dimethacrylate, alkoxylated neopentyl glycol diacrylate, alkoxylated neopentyl glycol dimethacrylate, cyclohexane dimethanol diacrylate, cyclohexane dimethanol dimethacrylate, diethylene glycol diacrylate, diethylene glycol dimethacrylate, dipropylene glycol diacrylate, dipropylene glycol dimethacrylate, ethoxylated (10) bisphenol A diacrylate, ethoxylated (1) bisphenol A dimethacrylate, ethoxylated (2) bisphenol A diacrylate, ethoxylated (2) bisphenol A dimethacrylate, ethoxylated (3) bisphenol A diacrylate, ethoxylated (3) bisphenol A dimethacrylate, ethoxylated (30) bisphenol A diacrylate, ethoxylated (30) bisphenol A dimethacrylate, ethoxylated (4) bisphenol A diacrylate, ethoxylated (4) bisphenol A dimethacrylate, ethoxylated (8) bisphenol A dimethacrylate, ethoxylated (8) bisphenol A dimethacrylate, ethoxylated (6) bisphenol A dimethacrylate, ethoxylated (6) bisphenol A dimethacrylate, ethylene glycol diacrylate,, ethylene glycol dimethacrylate, neopentyl glycol diacrylate, neopentyl glycol dimethacrylate, polyethylene glycol (200) diacrylate, polyethylene glycol (200) dimethacrylate, polyethylene glycol (400) diacrylate, polyethylene glycol (400) dimethacrylate, polyethylene glycol (600) diacrylate, polyethylene glycol (600) dimethacrylate, polypropylene (400) diethacrylate, polypropylene glycol (400) dimethacrylate, propoxylated (2) neopentyl glycol diacrylate, propoxylated (2) neopentyl glycol dimethacrylate, tetraethylene glycol diacrylate, tetraethylene glycol dimethacrylate, tricyclodecane dimethanol diacrylate, tricyclodecane dimethanol dimethacrylate, triethylene glycol diacrylate, triethylene glycol dimethacrylate, tripropylene glycol diacrylate, tripropylene glycol dimethacrylate, ethoxylated (15) trimethylolpropane triacrylate, ethoxylated (3) trimethylolpropane triacrylate, ethoxylated (15) trimethylolpropane triacrylate, ethoxylated (6) trimethylolpropane triacrylate, ethoxylated (9) trimethylolpropane triacrylate, ethoxylated (20) trimethylolpropane triacrylate, highly propoxylated (5.5) glyceryl triacrylate, low viscosity trimethylolpropane triacrylate, pentaerythritol triacrylate, propoxylated (3) glyceryl triacrylate, propoxylated (3) glyceryl trimethacrylate, propoxylated (3) trimethylolpropane triacrylate, propoxylated (6) trimethylolpropane triacrylate, trimethylolpropane triacrylate, trimethylolpropane trimethacrylate, tris (2-hydroxyethyl) isocyanurate triacrylate, tris (2-hydroxyethyl) isocyanurate triacrylate, ditrimethylolpropane tetraacrylate, dipentaerythritol pentaacrylate, ethoxylated (5) pentaerythritol tetraacrylate, low viscosity dipentaerythritol pentaacrylate, pentaacrylate ester, pentaerythritol tetraacrylate, alkyl (novolac) acrylate and urethane diacrylate.

7. The optical information storage medium of claim 1 wherein the first and/or second curable composition comprises at least one epoxy resin selected from the group consisting of glycidyl ester of mono- or dicarboxylic acid, butyl glycidyl ether, phenylglycidyl ether, 2-ethylhexyl glycidyl ether, 3-cyclohexenylmethyl-3-cyclohexenylcarboxylate diepoxide, 2-(3,4-epoxy)cyclohexyl-5,5-spiro-(3,4-epoxy)cyclohexane-m-dioxane, 3,4-epoxycyclohexylmethyl-3,4-epoxycyclo-hexanecarboxylate, 3,4-epoxy-6-methycyclohexylmethyl-3,4-epoxy-6-methyl-cyclohexanecarboxylate, vinyl cyclohexanedioxide, bis(3,4-epoxycyclohexyl-methyl)adipate, bis(3,4-epoxy-6-methylcyclohexylmethyl)adipate, exo-exo bis(2,3-epoxycyclopentyl) ether, endo-exo bis(2,3-epoxycyclopentyl) ether, 2,2-bis(4-(2,3-epoxypropoxy)cyclohexyl)propane, 2,6-bis(2,3-epoxypropoxy-cyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, p-(2,3-epoxy)cyclopentylphenyl-2,3-epoxypropylether, 1-(2,3-epoxypropoxy)phenyl-5,6-epoxy-hexadydro-4,7-methanoindane, o-(2,3-epoxy)cyclopentylphenyl-2,3-epoxypropyl ether), 1 ,2-bis(5-(1 ,2-epoxy)-4,7-hexahydromethanoindanoxyl)ethane, cyclopentenylphenyl glycidyl ether, cyclohexanediol diglycidyl ether, diglycidyl hexahydrophthalate, diglycidyl ether of bisphenol A and bisphenol F, alkyl glycidyl ether; alkyl- or alkenyl-glycidyl ester; alkyl-, mono- or poly-phenol glycidyl ether; polyglycidyl ether of pyrocatechol, resorcinol or hydroquinone, 4,4′-dihydroxydiphenyl methane, 4,4′-dihydroxy-3,3′-dimethyldiphenyl methane, 4,4′-dihydroxydiphenyl dimethyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, tris(4-hydroxyphyenyl)methane, polyglycidyl ether of the chlorination and bromination products of diphenols; polyglycidyl ether of novolacs; polyglycidyl ether of diphenols obtained by esterifying ethers of diphenols obtained by esterifying salts of an aromatic hydrocarboxylic acid with a dihaloalkane or dihalogen dialkyl ether, polyglycidyl ether of polyphenol obtained by condensing a phenol and a long-chain halogen paraffin containing at least two halogen atoms; phenol novolac epoxy resin; cresol novolac epoxy resin and sorbitol glycidyl ether.

8. The optical information storage medium of claim 1 wherein the first and/or second curable composition comprises at least one monomer selected from the group consisting of allyl glycidyl ether, vinyl glycidyl ether, glycidyl acrylate, glycidyl methacrylate, phenol novolak epoxide acrylate or methacrylate, cresol novolak epoxide acrylate or methacrylate and bisphenol A epoxide acrylate or methacrylate.

9. The optical information storage medium of claim 1 wherein the first and/or second curable composition contains at least one curing agent.

10. The optical information storage medium of claim 1 wherein the functionalized colloidal silica is obtained from the reaction of surface hydroxyl groups of colloidal silica with at least one functionalizing silane of the general formula:
(R¹)ₐSi(OR²)₄₋ₐ
wherein each R¹ is, independently, a monovalent alkyl, cycloalkyl, aryl, alkaryl or aralkyl group of up to 18 carbon atoms, optionally possessing at least one chemically reactive functionality selected from the group consisting of alkenyl, acrylate and epoxy.

11. The optical information storage medium of claim 10 wherein the functionalized colloidal silica is obtained from the reaction of surface hydroxyl groups of colloidal silica with a functionalizing silane in which each R¹ is the same or different alkyl, cycloalkyl, aryl, aryl, alkaryl or aralkyl group.

12. The optical information storage medium of claim 11 wherein the functionalizing silane is at least one member selected from the group consisting of phenyldimethylmethoxysilane, phenylmethyldimethoxysilane, cyclohexylmethyldimethoxysilane, phenyltrimethoxysilane and methyltrimethoxysilane.

13. The optical information storage medium of claim 10 wherein the functionalized colloidal silica is obtained from the reaction of surface hydroxyl groups of colloidal silica with (i) a functionalizing silane in which at least one R¹ is, or possesses, vinyl, allyl or acrylate functionality and (ii) a functionalizing silane in which at least one R¹ possesses epoxy functionality.

14. The optical information storage medium of claim 13 wherein the functionalizing silane is at least one silane selected from the group consisting of 2-(3,4-epoxycyclohexyl)ethyltrimethoxy-silane, 3-glycidoxypropyltrimethoxysilane, 3-acryloxypropylmethyldiethoxysilane, 3-acryloxyproplymethyldimethoxysilane, 3-acryloxypropyltrimethoxysilane, 2-methacryloxethylmethyldiethoxysilane, 2-methacryloxyethylmethyldimethoxysilane, 2-methacryloxethyltrimethoxysilane, 2-acryloxyethyltrimethoxysilane, 3-methylacryloxypropyl trimethoxysilane, 3-methacryloxypropyl-triethoxysilane, 3-acryloxypropyltriethoxysilane, 3-acryloxypropyldimethylethoxysilane, 2-methacryloxyethyltriethoxysliane and 2-acryloxyethyltriethoxysilane.

15. The optical information storage medium of claim 10 wherein the colloidal silica is reacted with from about 5 to about 60 weight percent thereof of functionalizing silane.

16. The optical information storage medium of claim 10 wherein the nominal median particle size of the colloidal silica does not exceed about 250 nm.

17. The optical information storage medium of claim 10 wherein the nominal median particle size of the colloidal silica does not exceed about 50 nm.

18. The optical information storage medium of claim 10 wherein the nominal median particle size of the colloidal silica does not exceed about 25 nm.

19. The optical information storage medium of claim 1 wherein the second curable composition further comprises at least one surface tension-reducing material.

20. The optical information storage medium of claim 1 wherein the second curable composition contains from about 50 to about 80 weight percent functionalized silica.
